(19) United States
(12) Patent Application Publication
(10) Pub. No.: US 2006/0053320 A1
(43) Pub. Date: Mar. 9, 2006

(54) Data processing system capable of reducing power consumption and method of the same

(76) Inventor: Chun-Hsueh Lin, Kwolnhun (TW)

Correspondence Address: HOFFMAN WARNICK & D'ALESSANDRO, LLC, 75 STATE STREET, 14TH FL, ALBANY, NY, 12207, US

(21) Appl. No.: 11/219,203

(22) Filed: Sep. 2, 2005

(30) Foreign Application Priority Data
Sep. 3, 2004 (TW) 093126595

(51) Int. Cl. G06F 1/26

(52) U.S. Cl. 713/300

(57) ABSTRACT

The present invention discloses a data processing system including a plurality of functional modules, a power control module, and a plurality of predetermined power profiles. The power control module is used for controlling ON/OFF of power for the functional modules. The predetermined power profiles correspond to a plurality of power control commands. When a predetermined power profile is selected from the predetermined power profiles, a corresponding predetermined power control command is transmitted to the power control module. According to the predetermined power control command, the power control module will selectively power ON/OFF the functional modules.

### BACKGROUND OF THE INVENTION

1. Field of the Invention

The present invention relates to a data processing system, especially to a data processing system capable of reducing power consumption.

2. Description of the Prior Art

In the prior art, the conventional computer always installs a plurality of modules therein or is connected to a plurality of devices. When the computer is powered on, almost all of the modules or devices will be also powered on at the same time. Even though the user only uses one of the modules or devices, other modules or devices are still powered on and that will consume a lot of power. Some conventional computers have the function of getting the modules or devices, whcih are not used during a predetermined span of time, into an idle state, so as to save the power. However, it still needs power for the modules or devices to detect the working signal from the computer all the time. Some computers, such as a notebook, always perform some applications for a lnog time without using certain modules or devices, and then the limited power of the battery may be rapidly out of use. For example, when a user uses a notebook to watch a DVD, the modules including a PCMCIA card, a universal serial bus (USB), and so on, are unused, but the power consumption of the modules is still considerable for the notebook while the DVD is played.

Of course, the user can remove the hot-plug support devices, such as a PCMCIA card, a USB, or a USB/1394 PCI-express device, from the computer. However, if the operating system of the computer is still running and the unused modules or devices, especially the non hot-plug functional modules or devices, are suddenly powered off, it may cause the computer a crash. Therefore, the objective of the present invention is to provide a computer capable of reducing power consumption to solve the above-mentioned problems.

### SUMMARY OF THE INVENTION

An objective of the present invention is to provide a data processing system capable of reducing power consumption.

Another objective of the present invention is to provide a power control method of the data processing system capable of reducing power consumption.

According to a preferred embodiment of the present invention, the data processing system includes a plurality of functional modules, a power control module, and a plurality of predetermined power profiles. The power control module is used for controlling ON/OFF of power for the functional modules. Each of the predetermined power profiles corresponds to a plurality of power control commands. When one of the predetermined power profiles is selected, a corresponding predetermined power control command is transmitted to the power control module. Afterward, according to the corresponding predetermined power control command, the power control module selectively powers ON/OFF the functional modules.

According to the power control method of a preferred embodiment of the present invention, a data processing system includes a plurality of functional modules and a power control module. The power control module is used for controlling ON/OFF of power for the functional modules. The power control method of the present invention includes the steps of: (1) providing a plurality of power profiles; (2) selecting one predetermined power profile from the power profiles; (3) transmitting a predetermined power control command corresponding to the predetermined power profile to the power control module; and (4) the power control module selectively powers ON/FF the functional modules according to the predetermined power control command.

In the data processing system or the power control method of the data processing system of the present invention, after one predetermined power profile is selected, a corresponding power control command is transmitted to the power control module, so as to power ON/OFF the corresponding functional modules. Accordingly, the unused functional modules will be powered OFF to reduce power consumption.

The advantage and spirit of the invention may be understood by the following recitations together with the appended drawings.

### BRIEF DESCRIPTION OF THE APPENDED DRAWINGS

FIG. 1 is a functional block diagram illustrating a data processing system according to a preferred embodiment of the present invention.

FIG. 2 is a flowchart illustrating the power control method of the data processing system shown in FIG. 1.

FIG. 3 is a functional block diagram illustrating a data processing system according to another embodiment of the present invention.

FIG. 4 is a flowchart illustrating the power control method of the data processing system shown in FIG. 3.

FIG. 5 is a functional block diagram illustrating a notebook according to another preferred embodiment of the present invention.

FIGS. 6A and 6B respectively illustrate an embodiment setting the notebook according to the predetermined power profile of the present invention.

FIG. 7 is a schematic diagram illustrating a user interface according to the present invention.

FIG. 8 is a schematic diagram illustrating a displayed frame after one power profile of the user interface shown in FIG. 7 is selected.

### DETAILED DESCRIPTION OF THE INVENTION

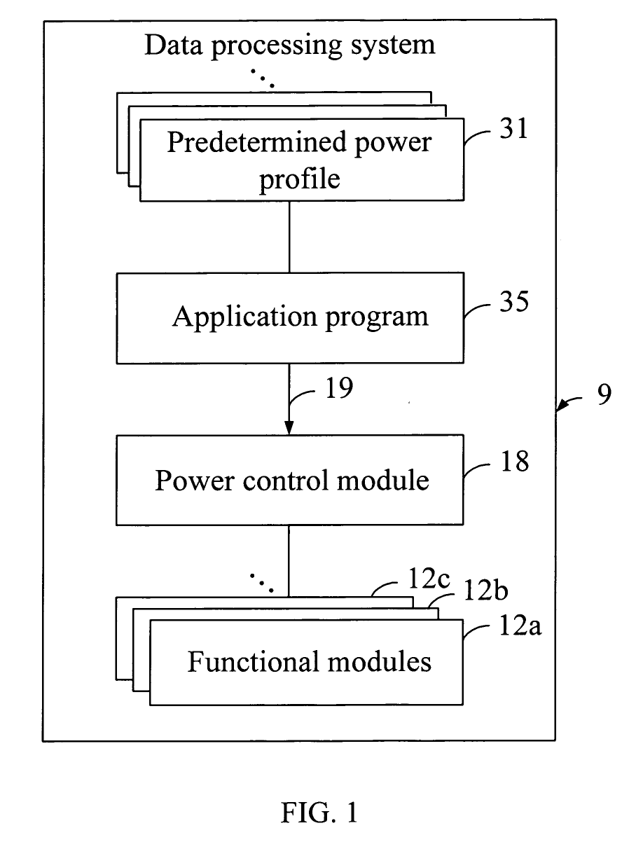

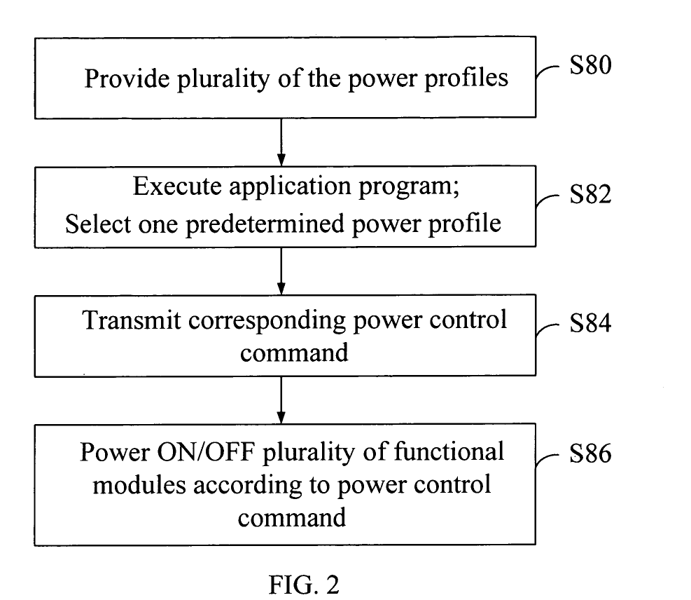

Please refer to FIG. 1 and FIG. 2. FIG. 1 is a functional block diagram illustrating a data processing system 9 according to a preferred embodiment of the present invention. FIG. 2 is a flowchart illustrating the power control method of the data processing system 9 shown in FIG. 1. The data processing system 9 includes a plurality of functional modules 12a, 12b, 12c . . . etc, a power control module 18, a plurality of predetermined power profiles 31, and an application program 35. The power control module 18 is used for controlling ON/OFF of power for the functional modules 12a, 12b, 12c . . . etc. The predetermined power profiles 31 correspond to a plurality of power control commands. In an embodiment, the data processing system 9 is a computer.

According to the present invention, the power control method includes the following steps. At start, step S80 is performed to provide a plurality of power profiles 31. Afterward, step S82 is performed. In step S82, the application program 35 is executed, and one predetermined power profile is selected from the power profiles 31. Step S84 is then performed. In step S84, a predetermined power control command 19 corresponding to the selected predetermined power profile is transmitted to the power control module 18. Step S86 is then performed. In step S86, the power control module 18 selectively powers ON/FF the functional modules 12a, 12b, 12c . . . etc according to the predetermined power control command.

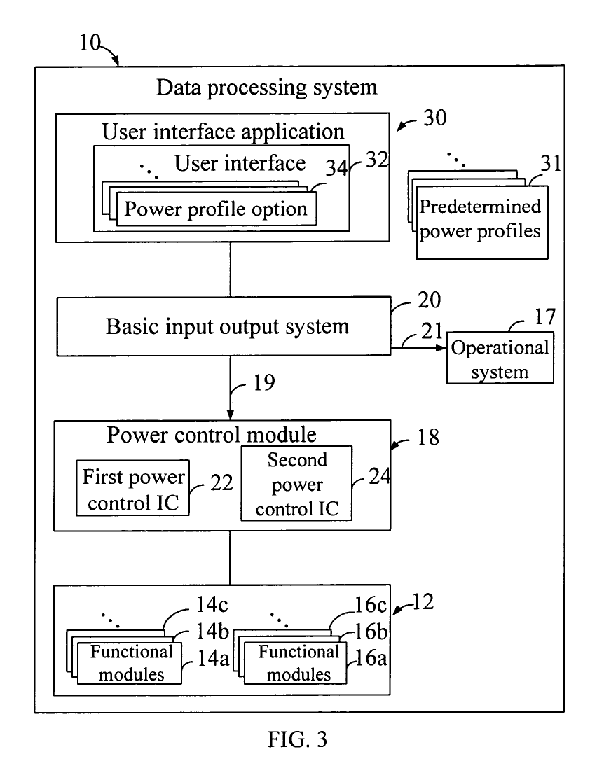

Please refer to FIG. 3. FIG. 3 is a functional block diagram illustrating a data processing system 10 according to another embodiment of the present invention. The data processing system 10 includes a plurality of functional modules 12, an operating system (OS) 17, a power control module 18, a plurality of predetermined power profiles 31, a basic input output system (BIOS) 20, and a user interface (UI) application 30.

Each of the functional modules is used for executing at least one specific function. These functional modules 12 can be grouped into two groups, wherein the first group includes the hot-plug support functional modules 14a, 14b, 14c . . . etc, and the second group includes the non hot-plug support functional modules 16a, 16b, 16c . . . etc.

The power control module 18 is used for controlling ON/OFF of power for the functional modules 12. The power control module 18 includes a first power control integrated circuit (IC) 22 and a second power control IC 24. The first power control IC 22 is used for controlling ON/OFF of power for the hot-plug support functional modules 14a, 14b, 14c . . . etc. in the first group, and the second power control IC 24 is used for controlling ON/OFF of power for the non hot-plug support functional modules 16a, 16b, 16c . . . etc. in the second group. In another embodiment, the first power control IC 22 and the second power control IC 24 can be also integrated into the same chip.

The UI application 30 provides a user interface 32 having a plurality of power profile options 34. The power profile options 34 correspond to the predetermined power profiles 31. The predetermined power profiles 31 correspond to a plurality of power control commands. The BIOS 20 includes the instructions necessary for basic operation of the data processing system 10. When one of the predetermined power profiles 31 is selected, a predetermined power control command 19 corresponding to the predetermined power profile is transmitted to the power control module 18. According to the predetermined power control command 19, the power control module 18 selectively powers ON/FF the functional modules 12.

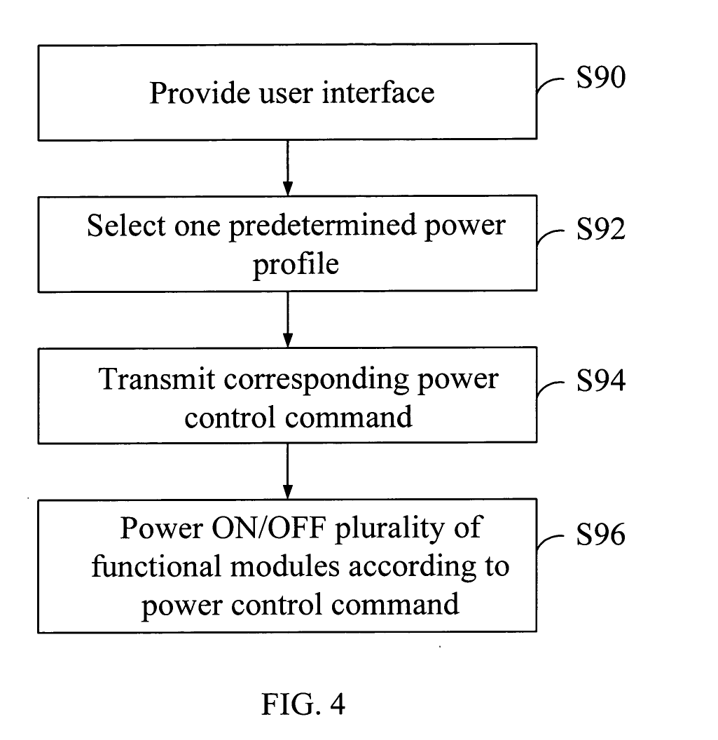

Please refer to FIG. 4. FIG. 4 is a flowchart illustrating the power control method of the data processing system 10 shown in FIG. 3. According to the present invention, the power control method includes the following steps. At start, step S90 is performed to provide a user interface 32. The user interface 32 includes a plurality of power profile options 34, which correspond to a plurality of perdetermiend power profiles 31. Afterward, step S92 is performed. In step S92, one of the power profile options 34 corresponding to one of the predetermined power profiles 31 is selected via the user interface 32. Step S94 is then performed. In step S94, a predetermined power control command 19 corresponding to the selected predetermined power profile 31 is transmitted to the power control module 18 directly via the BIOS 20. Step S96 is then performed. In step S96, the functional modules 14a, 14b, 14c . . . etc. and 16a, 16b, 16c . . . etc. are selectively powered ON/OFF according to the predetermined power control command 19. In step S96, when the predetermined power control command 19 transmitted to the power control module 18 is related to the hot-plug support functional modules 14a, 14b, 14c . . . etc. in the first group, ON/OFF of power is controlled by the first power control IC 22. When the predetermined power control command 19 transmitted to the power control module 18 is related to the non hot-plug support functional modules 16a, 16b, 16c . . . etc. in the second group, ON/OFF of power is controlled by the second power control IC 24.

In the data processing system and power control method thereof shown in FIG. 3 and FIG. 4, whenever the current power status of any of the the non hot-plug support functional modules 16a, 16b, 16c . . . etc. in the second group is changed, the BIOS 20 will transmit a notice signal 21 to the OS 17 and the OS 17 is thus acknowledged that the power status of the the non hot-plug support functional modules 16a, 16b, 16c . . . etc. in the second group has been changed. Accordingly, it won't cause the computer a crash.

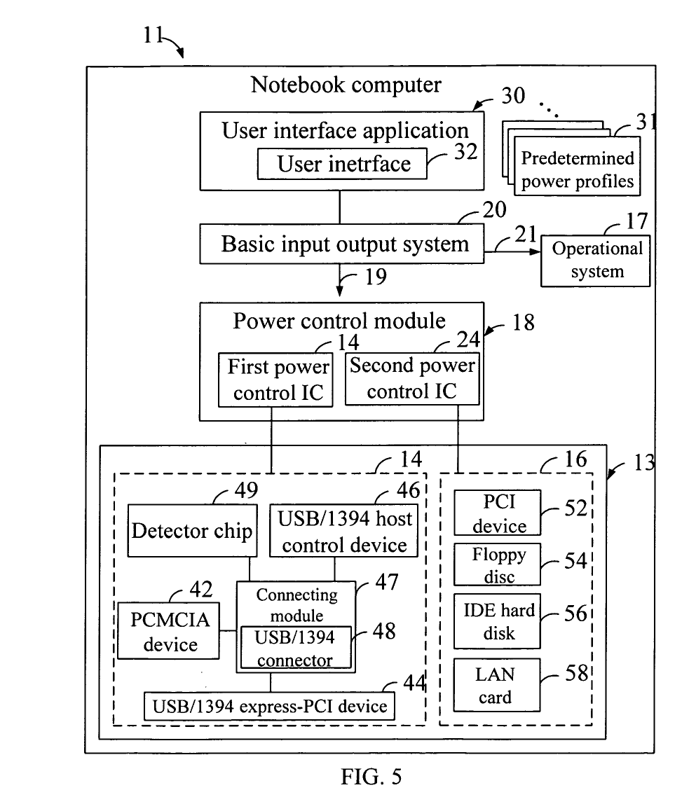

Please refer to FIG. 5. FIG. 5 is a functional block diagram illustrating a notebook 11 according to another embodiment of the present invention. In this embodiment, the data processing system of the present invention is applied in the notebook 11. The notebook 11 includes a plurality of functional modules 13, an operational system (OS) 17, a power control module 18, a basic input output system (BIOS) 20, and a user interface (UI) application 30. The user interface application 30 generates the power control command 19 to the power control module 18 directly via the BIOS 20 rather than via the OS 17. The power control method applied in the notebook 11 is the same with the data processing system 10 and the power control method thereof mentioned in the above. In the following, the power control method of the functional module 13 is described in detailed.

In the embodiment shown in FIG. 5, the functional modules 13 of the notebook 11 can be grouped into two groups, wherein the first group includes the hot-plug support functional modules 14 and the second group includes the non hot-plug support functional modules 16. The hot-plug support functional modules 14 in the first group include a PCMCIA device 42, at least one USB/1394 PCI-express device 44, and a USB/1394 host control device 46. In an embodiment, the PCMCIA device 42 is a PCMCIA card connected to the notebook 11 via a PCMCIA slot of a connecting module 47 (not shown). The USB/1394 PCI-express device 44 is connected to the USB/1394 host control device 46 via a USB/1394 connector 48. The notebook 11 further includes a detecting chip 49 for detecting whether the USB/1394 connector 48 is currently connected to the USB/1394 PCI-express device 44. Only one USB/1394 PCI-express device 44 is shown in FIG. 5.

In the embodiment shown in FIG. 5, the non hot-plug support functional modules 16 in the second group of the notebook 11 include a peripheral component interconnect (PCI) device 52, a floppy disk 54, a intelligent drive electronics (IDE) hard disk 56, and a local area network (LAN) card 58. Whenever the power control module 18 changes the current power status of any functional modules 52, 54, 56, and 58 of the non hot-plug support functional modules 16 in the second group, the BIOS 20 will transmit a notice signal 21 to the OS 17 and the OS 17 is thus acknowledged that the power status of the functional modules 52, 54, 56, and 58 in the second group has been changed.

When the power status of the non hot-plug support functional modules 16 in the second group is switched from ON to OFF by the predetermined power control command 19, for example, when the LAN card 58 is powered OFF, not only the power control module 18 powers OFF the LAN card 58, but also the BIOS 20 transmits the notice signal 21 to the OS 17, and the OS 17 thus disables the LAN card 58.

When the power status of the non hot-plug support functional modules 16 in the second group is switched from OFF to ON by the predetermined power control command 19, for example, when the LAN card 58 is powered ON, not only the power control module 18 powers ON the LAN card 58, but also the BIOS 20 performs initalization for the related register of the LAN card 58. Afterward, the BIOS 20 transmits a notice signal 21 to the OS 17, and the OS 17 is thus acknowledged that the current power status of the LAN card 58 has been changed and further enables the LAN card 58.

When the power status of the USB/1394 host control device 46 is switched from ON to OFF by the predetermined power control command 19, the power control module 18 will power OFF all the devices controlled by the USB/1394 host control device 46. When the power status of the USB/1394 host control device 46 is switched from OFF to ON, not only the power control module 18 will power ON all the devices controlled by the USB/1394 host control device 46, but also the BIOS 20 will perform initalization for the related register of the USB/1394 host control device 46. The BIOS 20 transmits a notice message to the OS 17, and the OS 17 is thus acknowledged that the current power status has been changed and further enables the USB/1394 host control device 46 and the related devices thereof.

When a hot-plug support device is connected to the connecting module 47, the detecting chip 49 transmits a signal to inform the BIOS 20 in case the USB/1394 host control device 46 is powered OFF. The BIOS 20 performs initialization for the related registor of the USB/1394 host control device 46. The BIOS 20 transmits a notice message to the OS 17, and the OS 17 is thus acknowledged that the current power status has been changed, and then the first power control IC 14 will power ON the hot-plug support device.

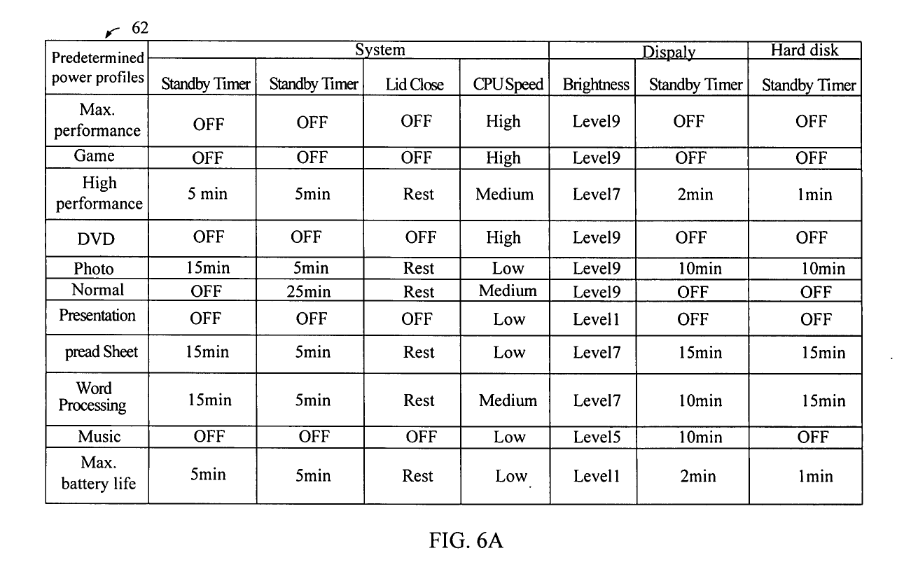

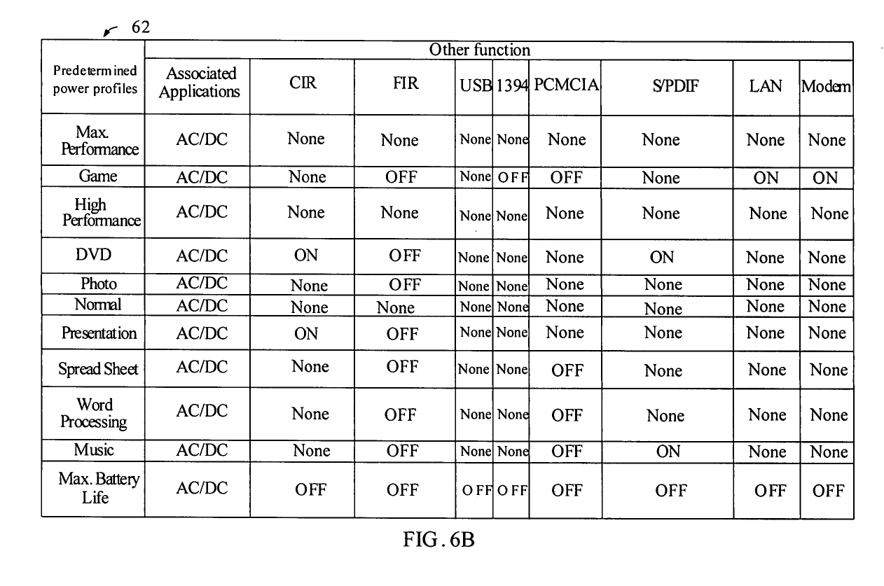

According to the present invention, the predetermined power profiles can be devised in advance based on the personal common usage. There are various settings related to the power control for powering OFF the unused functional modules, so as to reducing power consumption. Please refer to FIGS. 6A and 6B. FIGS. 6A and 6B respectively illustrate an embodiment setting the notebook according to the predetermined power profile of the present invention. In the FIGS. 6A and 6B, the first column 62 in the table shows different predetermined power profiles, and the following columns respectively show ON/OFF of power for all kinds of functional modules or settings related to power control. For example, “Game” represents that when the computer is used to play the computer games, the standby timer and the hibernation timer of the computer, the lid close, and the standby timer of the monitor all are powered OFF. When a user is playing computer games, the standby timers are unused, so lot of power will be saved. On the other hand, the brightness of the monitor is maintained in the level 9, i.e. the highest brightness, and the rate of CPU is the highest, so as to provide the user with a better quality for playing games.

Furthermore, when a user just uses the computer to listen music, a plurality of functional modules is unused and may be powered OFF. Accordinglt, the functional modules related to far infrared (FIR) and PCMCIA are powered OFF, the functional modules related to the Sony/Philips digital interface (S/PDIF) are poweed ON, and the functional modules related to the committed information rate (CIR), USB, 1394, LAN, and modem remain unchanged. In the FIGS. 6A and 6B, the setting marked as “None” represents the status remains unchanged. As for each of the parameters and the meaning thereof is the well-known prior art and the related description is neglected. In another embodiment, different predetermined power profiles can be devised for the user to select. When devising a predetermined power profile in practice, all corresponding requirements of ON/OFF of power for the functional modules are taken into consideration.

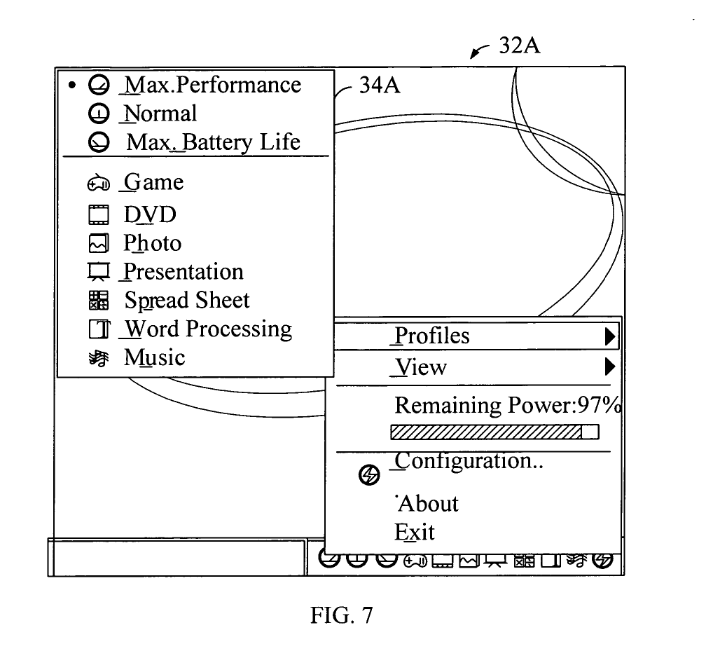

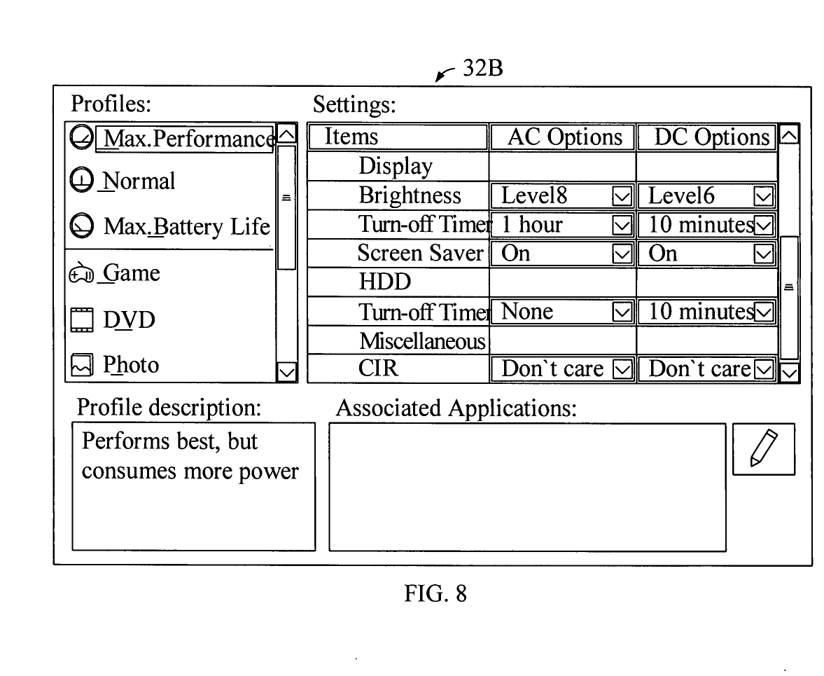

Please refer to FIG. 7 and FIG. 8. FIG. 7 is a schematic diagram illustrating a user interface 32A according to the present invention. FIG. 8 is a schematic diagram illustrating a displayed frame 32B after one power profile option 34A of the user interface 32A shown in FIG. 7 is selected. When a user wants to control ON/OFF of power, according to the present invention, the user interface provided by the data processing system or the computer is used to select one from the predetermined power profile options. The power profile option 34A of the user interface 32A shown in FIG. 7 is corresponding to the predetermined power profiles 62 shown in FIGS. 6A and 6B. For example, when a user selects “Max. Performance” from the power profile options, the frame 32B shown in FIG. 8 is diaplayed at the same time to show the settings related to “Max. Performance”. Accordingly, a user can select the most appropriate power profile option based on his/her requirement, and the unused functional modules will be powered OFF, so that the objective of reducing power consumption can be achieved.

Compared to the prior art, the data processing system or the power control method thereof is to transmit a power control command corresponding to a selected predetermined power profile to the power control module, so as to power ON/OFF the corresponding functional modules. Therefore, the unused functional modules are powered OFF to reduce power consumption. Furthermore, when the current power status of any of the non hot-plug support functional modules in the second group is changed, the OS receives a notice message and is thus acknowledged the current power status of a functional module has been changed, so as to avoid causing the computer a crash.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A data processing system, comprising:
a plurality of functional modules;
a power control module for controlling ON/OFF of power for the plurality of functional modules; and
a plurality of predetermined power profiles wherein each of the predetermined power profiles corresponds to the ON/OFF of power for the plurality of functional modules and corresponds to a plurality of power control commands;
wherein when one of the plurality of predetermined power profiles is selected, a corresponding predetermined power control command is transmitted to the power control module, and according to the corresponding predetermined power control command, the power control module selectively powers ON/OFF the plurality of functional modules.

2. The data processing system of claim 1, further comprising:
a user interface (UI) application for providing a user interface having a plurality of power profile options, which correspond to the plurality of predetermined power profiles;
a basic input output system (BIOS) comprising instructions necessary for basic operation of the data processing system;
wherein when the power profile is selected from the plurality of power profile options, the user interface application generates the predetermined power control command to the power control module directly via the BIOS.

3. The data processing system of claim 1, wherein the plurality of functional modules is grouped into the hot-plug support functional modules in a first group and the non hot-plug support functional modules in a second group.

4. The data processing system of claim 3, wherein the power control module comprises a first power control integrated circuit (IC) and a second power control IC, and wherein the first power control IC is used for controlling the power of the hot-plug support functional modules in the first group and the second power control IC is used for controlling the power of the hot-plug support functional modules in the second group.

5. The data processing system of claim 4, wherein the data processing system is a computer comprising an operating system (OS), and the user interface application generates the power control command to the power control module directly via the BIOS rather than via the OS.

6. The data processing system of claim 5, wherein whenever the power control module changes the current power status of any of the non hot-plug support functional modules in the second group, the BIOS transmits a notice signal to the OS and the OS is thus acknowledged that the current power status of the non hot-plug support functional modules in the second group has been changed.

7. The data processing system of claim 3, wherein the hot-plug support functional modules in the first group comprise a PCMCIA device, at least one USB/1394 PCI-express device, and a USB/1394 host control device.

8. The data processing system of claim 7, wherein the USB/1394 PCI-express device is connected to the USB/1394 host control device through a USB/1394 connector, and the data processing system further comprises a detecting chip for detecting whether the USB/1394 connector is currently connected with a USB/1394 PCI-express device.

9. The data processing system of claim 3, wherein the non hot-plug support functional modules in the second group comprise a PCI device, a floppy disk, an IDE hard disk, and a LAN card.

10. The data processing system of claim 1, wherein the data processing system is a computer comprising an application program for selecting the predetermined power profile from the plurality of predetermined power profiles.

11. A power control method of the data processing system, the data processing system having a plurality of functional modules and a power control module, and the power control module is used to control ON/OFF of power for the plurality of functional modules, the power control method comprising the following steps of:
providing a plurality of power profiles;
selecting one predetermined power profile from the plurality of power profiles;
transmitting a predetermined power control command corresponding to the predetermined power profile to the power control module; and
the power control module selectively powers ON/OFF the plurality of the functional modules according to the predetermined power control command.

12. The power control method of claim 11, wherein the data processing system further comprises a basic input output system (BIOS), and the BIOS comprises instructions necessary for basic operation of the data processing system, the method further comprising the following steps of:
providing an user interface having a plurality of power profile options, which correspond to the plurality of predetermined power profiles;
transmitting the predetermined power control command to the power control module directly via the BIOS after the predetermined power profile has been selected from the user interface.

13. The power control method of claim 11, wherein the plurality of functional modules is grouped into the hot-plug support functional modules in a first group and the non hot-plug support functional modules in a second group.

14. The power control method of claim 13, wherein the power control module comprises a first power control integrated circuit (IC) and a second power control IC, and wherein the first power control IC is used for controlling the power of the hot-plug support functional modules in the first group and the second power control IC is used for controlling the power of the hot-plug support functional modules in the second group.

15. The power control method of claim 14, wherein the data processing system is a computer comprising an operating system (OS), and the user interface application generates the power control command to the power control module directly via the BIOS rather than via the OS.

16. The power control method of claim 15, wherein when the power control module changes the current power status of any of the non hot-plug support functional modules in the second group, the BIOS transmits a notice signal to the OS, and the OS is thus acknowledged that the current power status of the non hot-plug support functional modules in the second group has been changed.

17. The power control method of claim 13, wherein the hot-plug support functional modules in the first group comprise a PCMCIA device, at least one USB/1394 PCI-express device, and a USB/1394 host control device.

18. The power control method of claim 17, wherein the USB/1394 PCI-express device is connected to the USB/1394 host control device through the USB/1394 connector, and the data processing system further comprises a detecting chip for detecting whether the USB/1394 connector is currently connected with the USB/1394 PCI-express device.

19. The power control method of claim 13, wherein the non hot-plug support functional modules in the second group comprise a PCI device, a floppy disk, an IDE hard disk, and a LAN card.

20. The power control method of claim 11, wherein the data processing system is a computer comprising an application program, the method further comprising the following step of:
executing the application program to select the predetermined power profile from the plurality of the predetermined power profiles.
